(19) United States
(12) Patent Application Publication
(10) Pub. No.: US 2010/0082253 A1
(43) Pub. Date: Apr. 1, 2010

(54) Strategic management system to stop the development of hurricanes and abate the intensity of tropical storms and hurricanes

(76) Inventor: William E. Buchanan, Columbia, MD (US)

Correspondence Address: WILLIAM E. BUCHANAN, 11089 SWANSFIELD RD, COLUMBIA, MD, 21044, US

(21) Appl. No.: 12/284,997

(22) Filed: Sep. 26, 2008

(51) Int. Cl. G01W 1/10

(52) U.S. Cl. 702/3

(57) ABSTRACT

The disclosure consists of a system made up of three state-of-the-art subsystems that (1) process historical and real-time data to establish the most likely path that a tropical storm will take, and track and predict the future path that it is taking or will take. These data and temperature readings of the tropic surface water are used to determine locations, timing, and quantity of cool water (many millions of gallons) to be dispersed from a second subsystem (2) which consists of cool-water producing, state-of-the-art equipment on platforms located at selected land sites, moored at sea or carried aboard slowly grazing barges or ships. Instructions for dispersion are managed by a system analyzer in the third (3) Communications subsystem, which sends them in a coordinated way to platforms where regular surface water temperature readings are made and reported regularly as additional data used in the decision-making process to determine where, when and how much cool water should be dispersed at each platform.

### BACKGROUND

According to the Union of Concerned Scientists in a paper titled “Global Warming”, three factors must be present for development of cyclonic storms, such as the hurricanes that occur in the South Atlantic and The Caribbean Sea and threaten and damage the Eastern Seaboard and Gulf of Mexico. They are water temperature above 79 degrees Fahrenheit, low vertical wind shear (no change in wind speed and direction between two different altitudes, and high humidity. There are several ways that nature sometimes “puts the brakes on” a tropical cyclone: strong winds churning up and bringing cooler water to the surface; high wind shear (in which moist air rises and releases heat as it condenses and turns to rain); dry air migrating to the core and moving over land, which provides frictional drag and deprives the storm of warm water and rising moist air; and, of course, a storm's encountering cooler water from whatever cause. Of these abatement tools, cooling the ocean's surface with cooler water has been the premise and focus of two recent patents. Warming the broad surface area by several degrees is, primary the goal of this application which will demonstrate that it can be done with a system consisting of existing and verifiable information and with state-of-the-art equipment. The preferred embodiment and variations in this application will provide complete details of the system design which was previously summarized in provisional application No. 60/997,414

### PRIOR ART

The proposed patent overcomes perceived deficiencies of two recent U.S. patent 20070101921 “Method for Hurricane Prevention” and 20040011881 “Method and Apparatus for Abating Storm Strength,” which claim the ability to abate cyclonic storms using surface submarines and surface vessels in cooling tropical surfaces in advance of the arrival of tropic storms and cyclones. Without questioning the practicality of obtaining the considerable apparatus that needs to be obtained or developed to support claims of these patents, clearly neither of them offers a factual basis for claiming that they cold provide a sufficient amount of cooling water to abate hurricanes in the 50 mile wide or broader swaths and many possible locations that major hurricanes are likely to develop from tropical storms. They also do not make clear how various ships they might employ could stay ahead of tropical storms traveling at speeds up to 20 knots with surface swells as high as 12 feet well in advance of a storm's' approach. They also employ unspecified long cold water pipes, for pumping up water from the depths without indicating g how or where they would be obtained or made. Nor how they might affect the performance, or ships' survival while being dragged through the sea on their undersides while traveling at high speeds. Where the ships and energy to run them would be obtained and maintained also are left to the imagination, except in one embodiment calling for a large number of Navy surface vessels. Determining the likely appearance and progress of tropical storms from historical or from real-time data is also vague, as is the time needed to keep the sea cooled n advance of a storm. The referenced inventions also seem to ignore the fact that for maximum cooling of the surface, really cold water from depths of 1000 feet or more would be needed and that flexible pipes that can reach down 1000 feet exist, but none when moving faster than 5 or so miles an hour.

The detailed preferred embodiment of the invention being applied for here will address and show that these issues have either already been solved or how they can be solved by the system, subsystems and state-of-the-art methods and equipment proposed and described in the preferred and other embodiments.

### SUMMARY DESCRIPTION OF INVENTION

It is a strategic management system to stop, abate or maintain the intensity of tropical storms and tropical cyclones (hurricanes), especially the rare but devastating category 4 and 5 “cape verde” hurricanes that cross the Atlantic from the west coast of Africa and, typically arrive as tropical depressions in the South Atlantic in early August. And hurricanes that develop suddenly over very warm waters. The system includes three closely integrated state-of-the-art subsystems: (1) a data-based subsystem (historical and real-time data), which, in the United States, is continuously provided by the National Hurricane Center (NHC). The historical data analyzer identifies the path in 200 to 300 mile wide areas across the South Atlantic, the Caribbean Sea and the Gulf of Mexico and in other tropical waters where tropical storms, originate or appear. The NHC provides a real-time data analyzer tracking the daily course, strength, size, direction and progress of storms and hurricanes from the day that a storm appears. (2) A second state-of the-art subsystem would spread millions of gallons of cool water on the Caribbean surface as soon as a storm is recognized by the data subsystem. The cool water swath(s) would be at least twice as wide as the storms (which typically are 50 miles across with eye diameters of 25 miles. The water would be dispersed on the surface as single or multiple emissions from land or moored platforms, or from barges grazing slowly at sea. State-of-the art technology producing 1 MWe per installation and 800 million gallons of water per day per installation was first demonstrated in Hawaii more than thirty years ago. Daily temperature measurements would be taken from each platform and reported to (3) A third “Communications” management, and decision-making subsystem that is in regular communications with the platforms. This subsystem evaluates the need for water dispersion to cool the waters in the vicinity of the platforms and periodically sends commands to the platforms using standard state-of-the-art electronic communications means—e.g. radio-telephone and email-specifying amounts and durations of dispersions required to cool the waters sufficiently to stop or slow the development of storms and hurricanes . . . .

### EMBODIMENTS

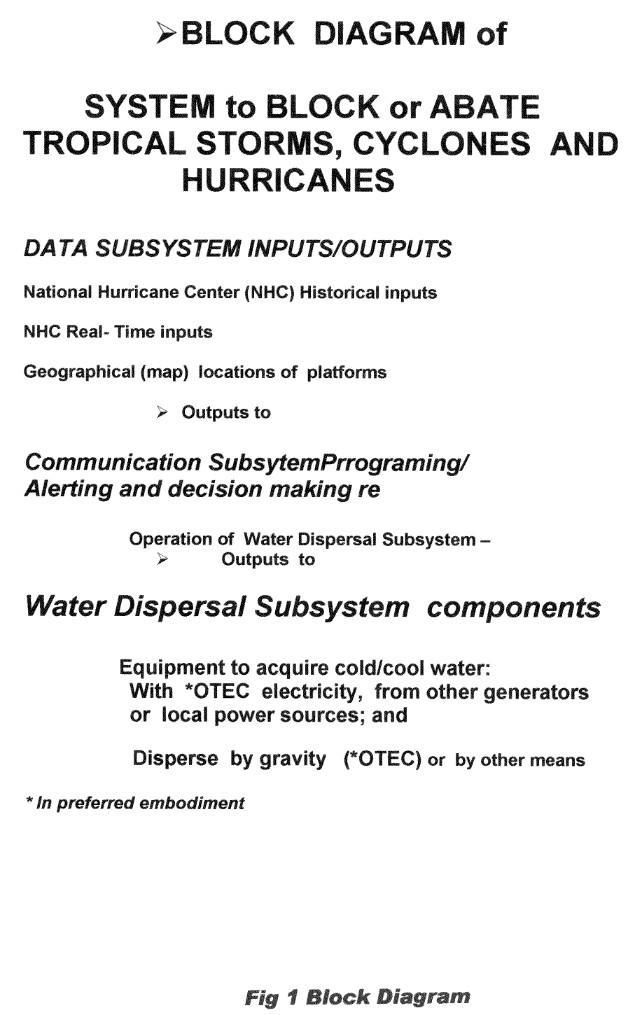

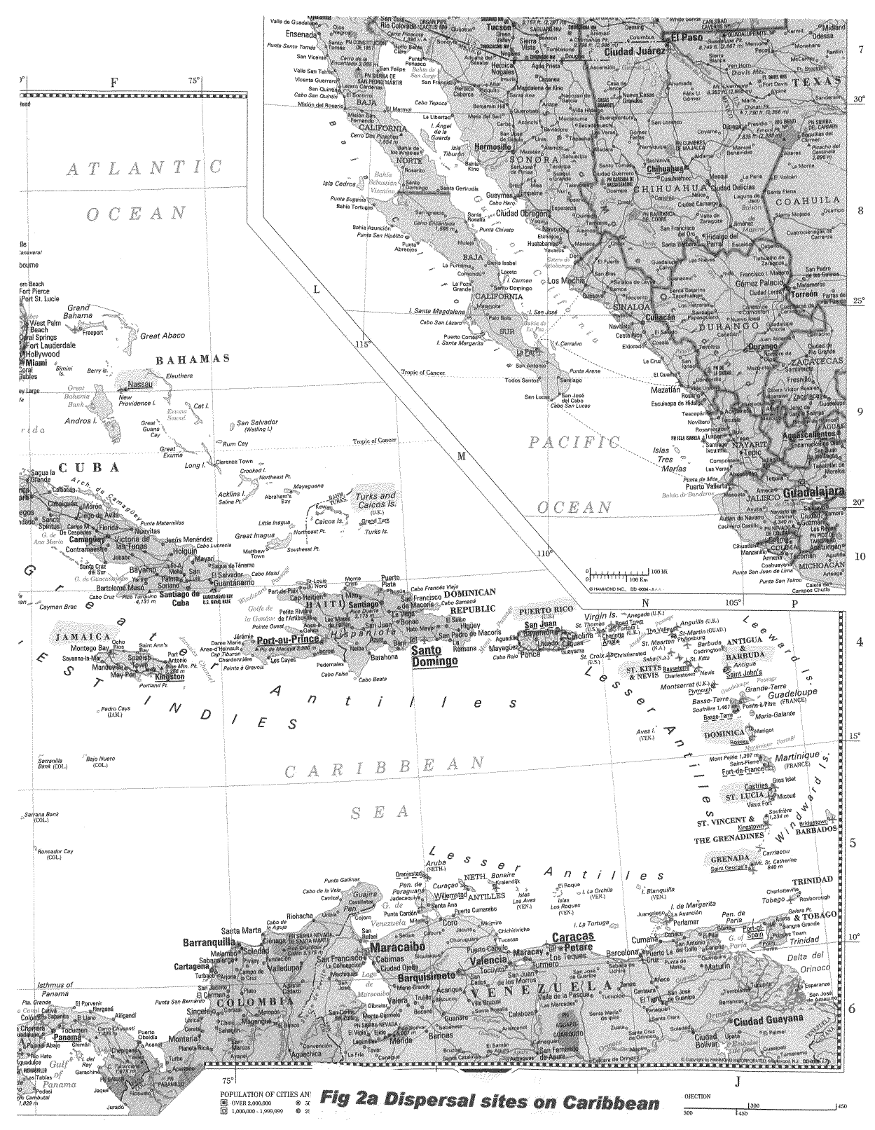

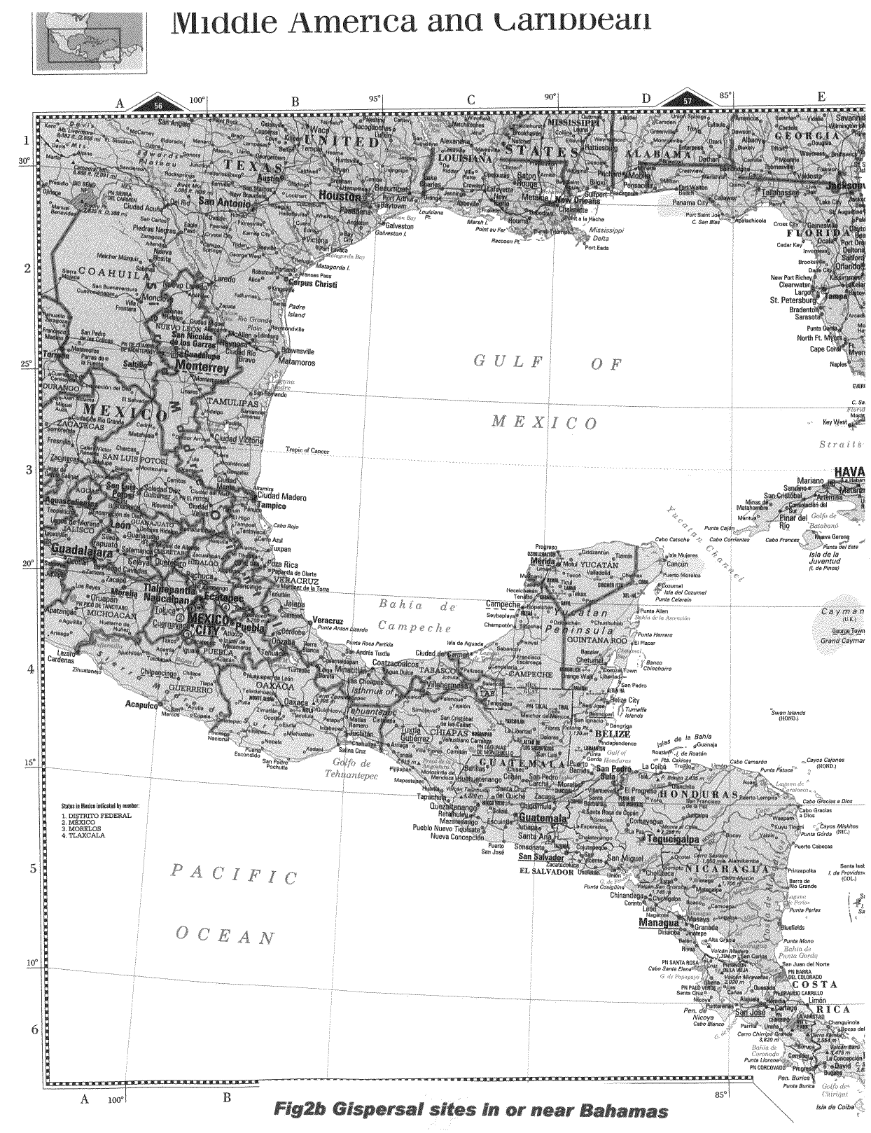

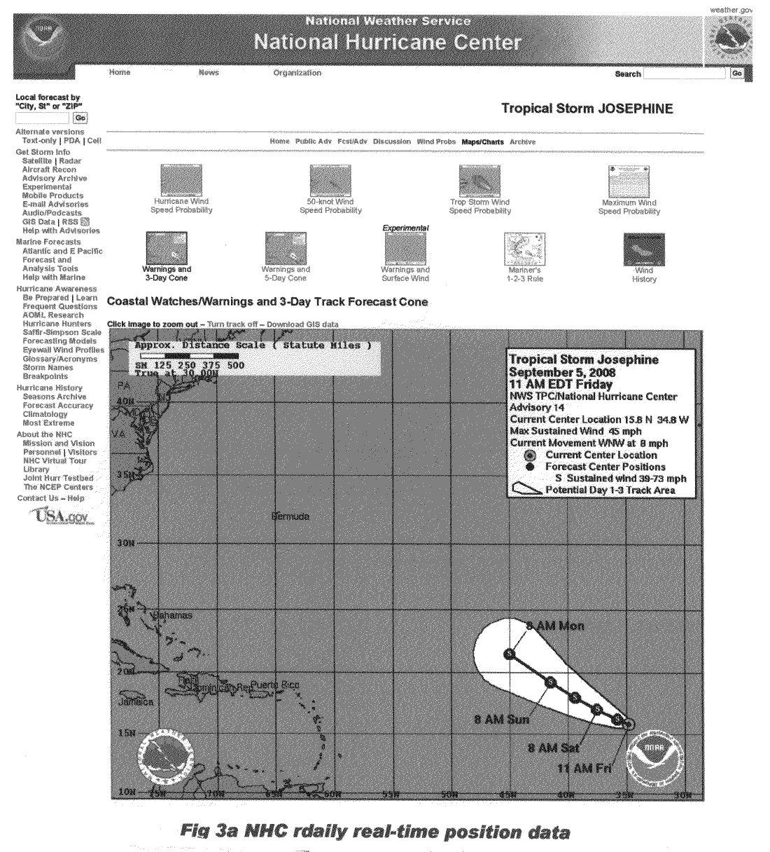

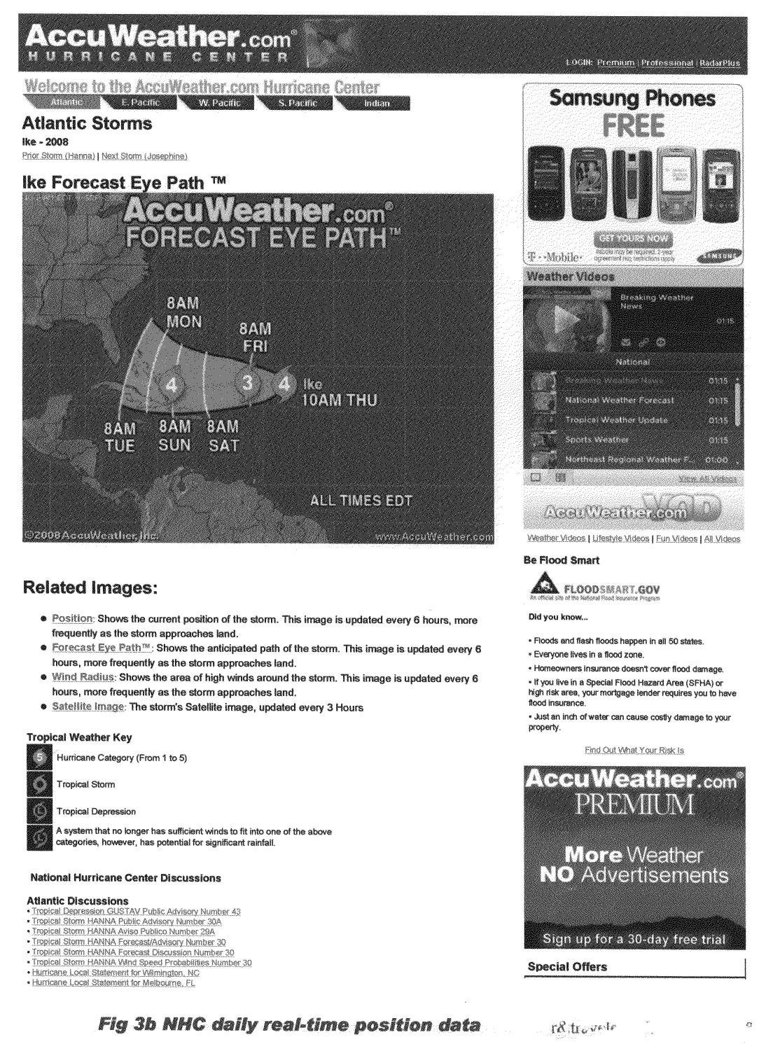

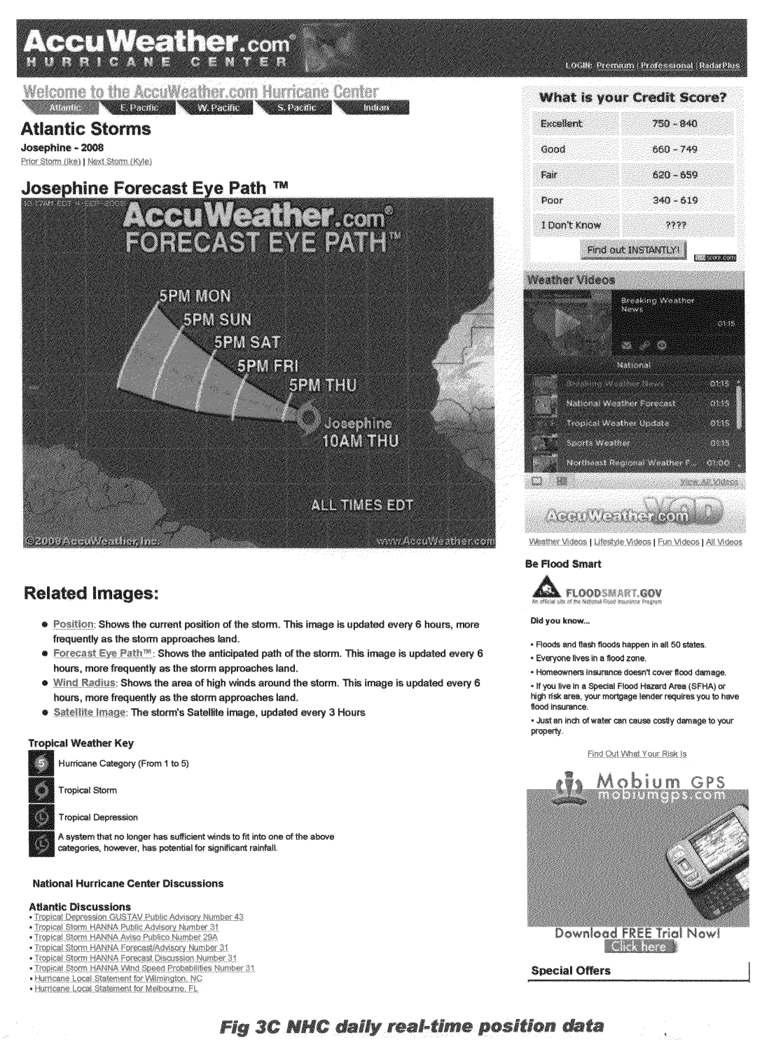

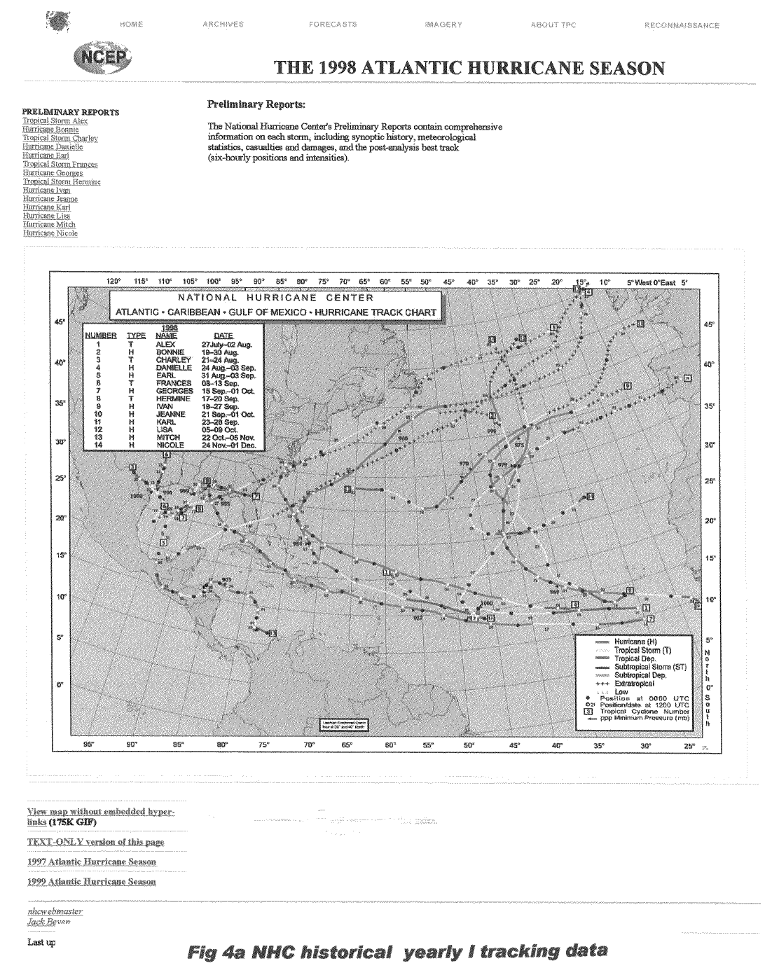

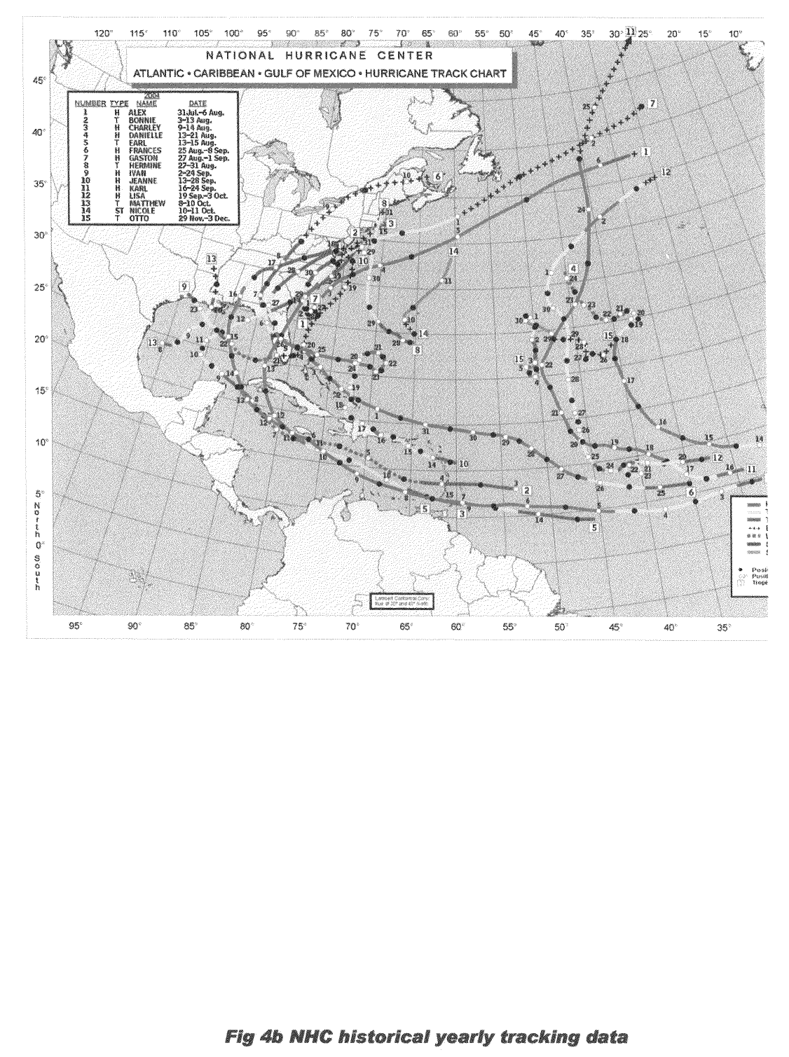

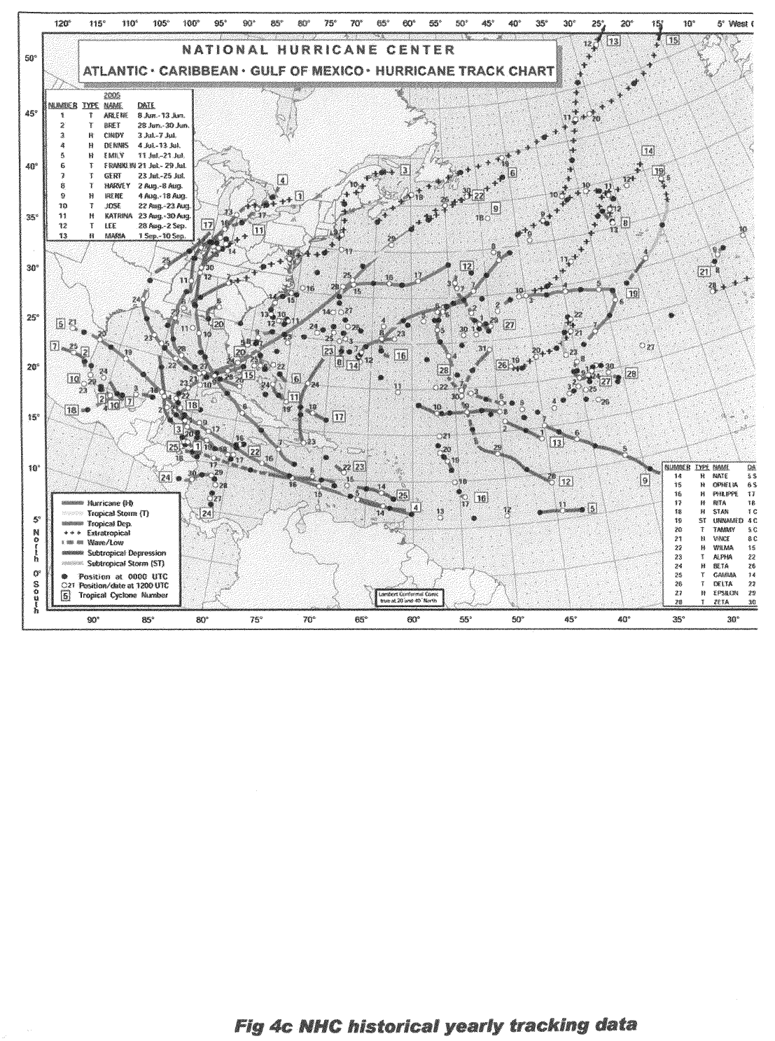

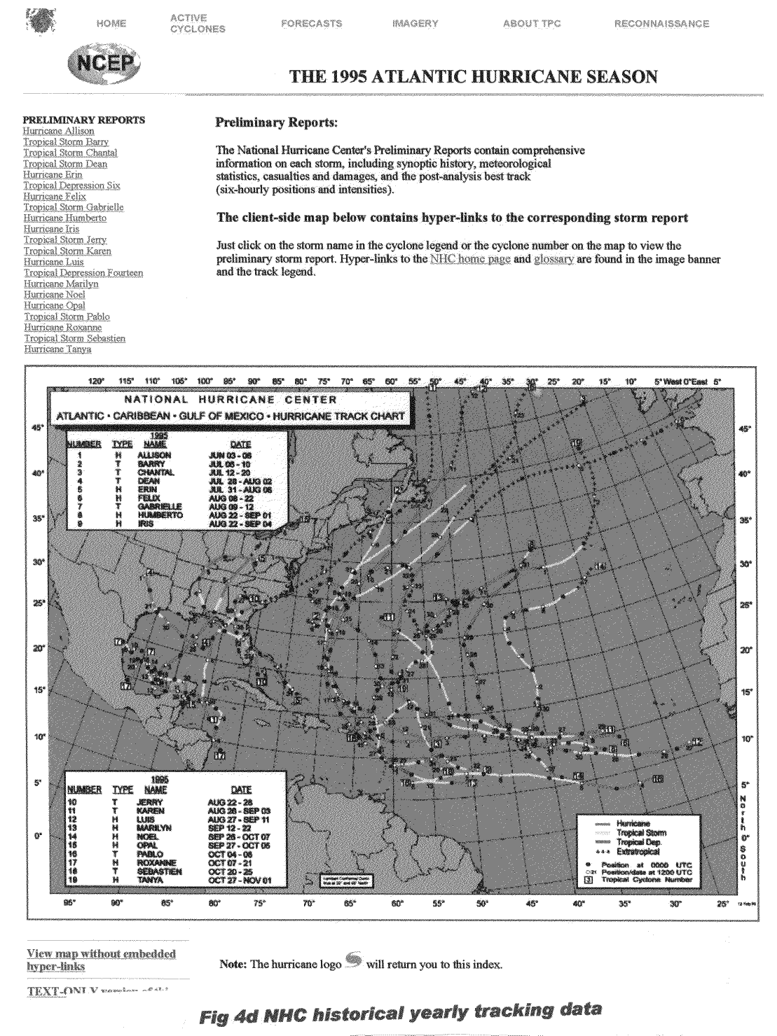

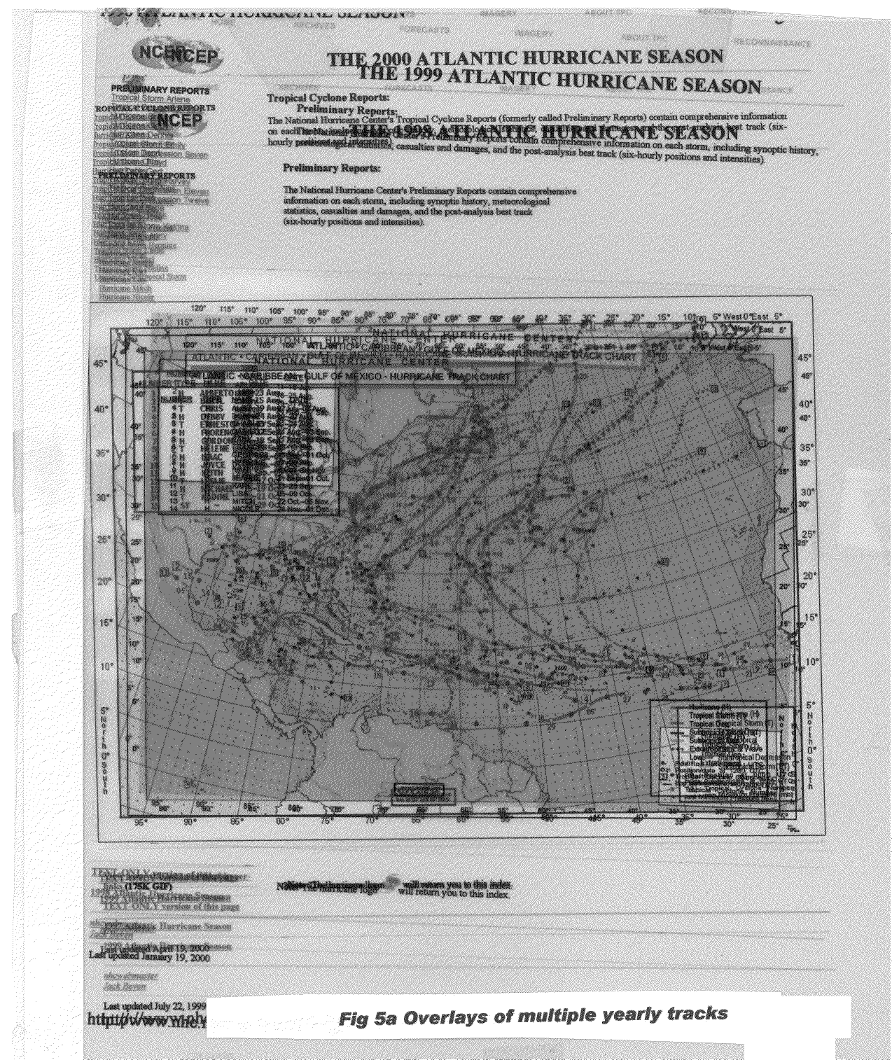

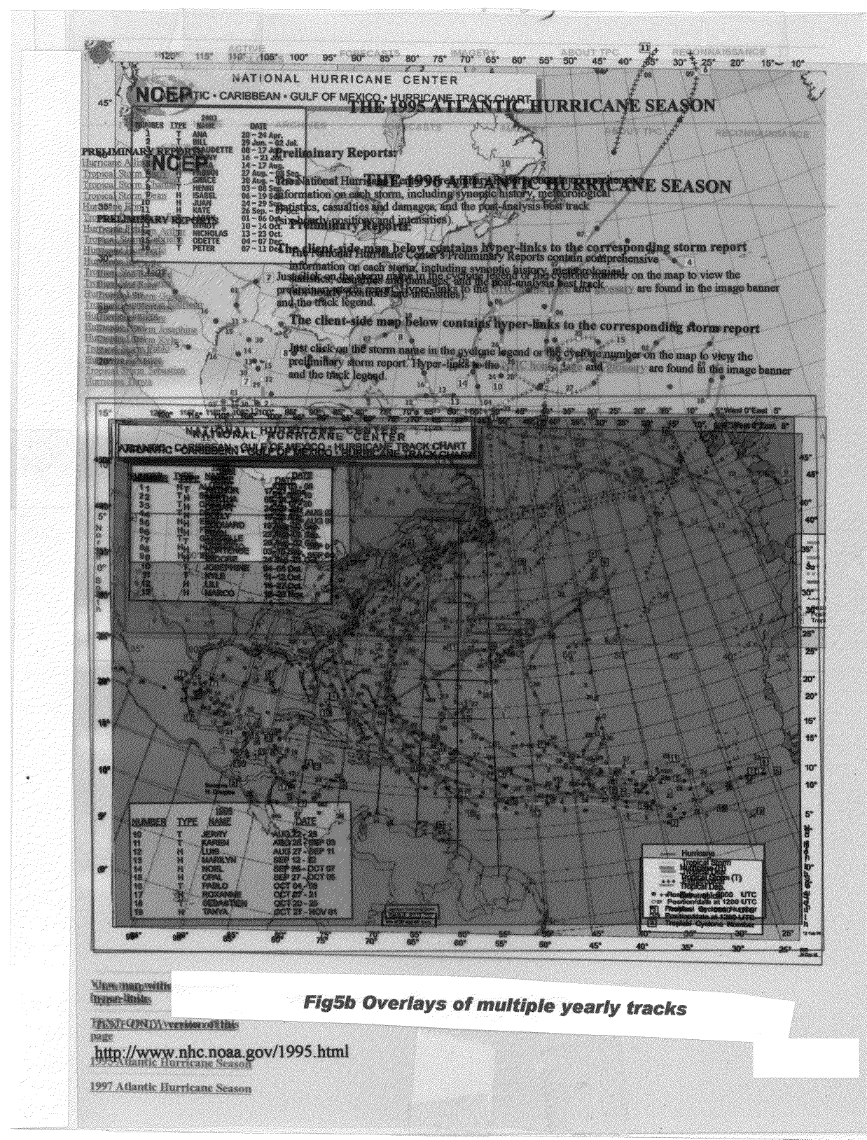

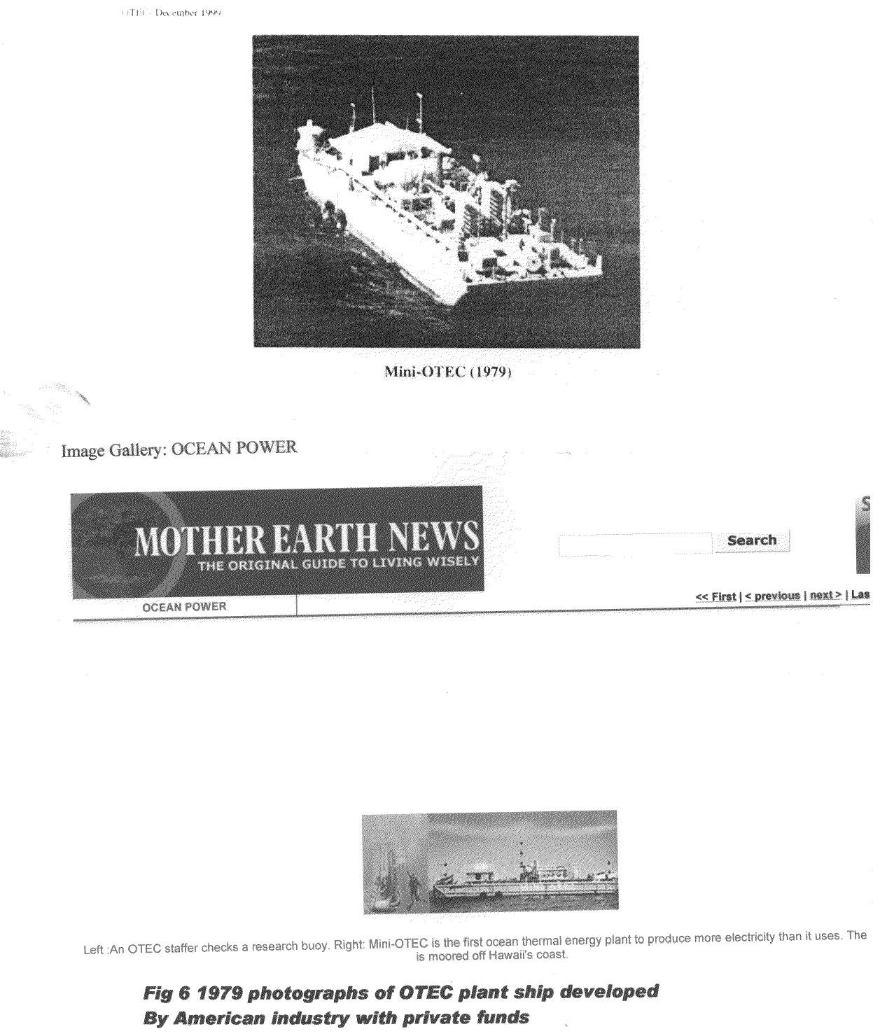

This invention can be reduced to practice in several different ways all of which would initially require completing data communication and equipment requirements of three subsystems of a system to stop or reduce the intensity of tropical cyclones and storms, especially Atlantic hurricanes. (See FIG. 1 block diagram of the system and its subsystems) Specifics of the embodiments will be significantly affected by the geographical area in which the disturbances appear, e.g the CaribbeanSea; Bay of Bengal; the quantity and temperature of cool water that needs to be dispensed to cool the sea surface ahead of tropical storms sufficiently to lower the surface temperature in multiple 50 mile wide tracking areas to less than 77 degrees or less year round. (The average Caribbean surface temperature is 78 F from November through May and 83 F from June through October.) The availability of electricity to power the dispersal sites (land or sea based platforms, or slowly grazing barges) and the availability of radio or email communications among the platforms are important considerations, as are funding that might be available to create the initial and subsequent system and get it working. In any event, it will be shown in the preferred and other embodiments that all of the technology needed to reduce this proposed system patent to practice now exists or may be assembled with minor adaptations familiar to people knowledgeable in the technology and equipments used in pumping large amounts of water from depths of 1000 feet or more and horizontal distances of 25 miles or less.

The preferred embodiment described in the ensuing pages and illustrated by a drawing and pictures will be seen as flexible in terms of many specifics. It was chosen because it can readily be reduced to practice and demonstrate that the claims made can be met.

### Data Subsystem:

First, before any physical equipment is specified, this subsystem analyzes historical and real-time data provided by the National Hurricane Center. starting with periodic data (storm tracks). See example figures. When a real-time display reveals that a tropical depression or storm has arisen, is being tracked and is most likely to be heading in a certain map direction, the Communications subsystem of the system is alerted to prepare any and all platforms for the need to disperse cool water by the Dispersal subsystem. Prior to this, archival pictures showing many years of tropical storms will have been analyzed to predict the likely path of the incipient storm. See overlay figures. Archival conclusions are reviewed yearly to take into account new ones that appear significant. The Data subsystem also contains a constant geographical picture of islands and other locations in the Caribbean and Bahamas with depths of 1000 feet or more. (See drawings 2 & 3. 7 for locations marked in yellow chosen as possible dispersal sites based on information given by Richard Crews in his article “OTEC Sites” available on his eb site . . . .

After a tropical storm has been identified, and dispersal sites selected or reconfirmed, a message will be sent by email with radio backup from the he base site, where the initial predictions are e made, to other sites, if any, where dispersions are to begin, continue or require different dispersion(s) from those that may already be in progress.

### Communications Subsystem

The preferred embodiment of this subsystem requires the location of a personal computer and an HFSSB marine radio for voice communications at each platform. (Ship Com Corp. provides voice and email communications in the Caribbean.) To send and receive voice and text email messages between land-based or moored platforms, or grazing barges each one would have an operating radio, personal computer and a radio modem such as the one manufactured by Kantronics, including at the base platform, which serves as the communications center for the overall system (as well as a dispersal sitete for cool water). The Dispersal subsystem is described in the next paragraph, where the preferred embodiment calls for up to 10 platforms. In practice, the Communications subsystem located on the base platform would send verbal alerts to all platforms in the system. The base platform would receive periodic printed email data from the computers on each platform indicating surface water temperature; then combine these inputs s with current and predicted storm location proved by NHC. To decide specific commandsti emaul to the dispersal sites. Existing voice and email systems are the preferred embodiment of the communication subsystem because there would be personnel assigned to each platform who could oversee and make quick adjustments to the commands. (Those skilled in the arts of computer programming and digital communications will, however, recognize that automatic alerts, transmission of temperature readings and prescriptions for, amounts and timing of dispersals could be programmed and transmitted by computer. Computerizing these functions would add to the initial cost of establishing the network and would not decrease the likelihood of errors or significantly reduce operating costs.

### Water Dispersal Subsystem

The preferred embodiment of this subsystem is essentially the adaptation of existing Ocean Thermal Energy Conversion (OTEC) platforms and related proven technology to the dispersal of the large quantities of cold or cool ocean water to large (50 mile square or larger) areas in the Atlantic, Caribbean Sea, and other large areas where tropical depressions develop into tropical storms and often become cyclones and hurricanes. (The principles of how OTEC can generate electrical power and at the same time produce large quantities of desalinated cold water are described in U.S. Pat. No. 5,582,691, and by more current articles (printed on the Internet) by the large Hawaiian firm OCEES entitled “Fresh Water Production from An Abundant Resource” and “Fuel and Emission Free Power and Water Production Integrated Ocean Thermal Energy Conversion (OTEC) System.”

Proof that an OTEC system of the type proposed for spreading cold water on multiple areas of the Caribbean Sea by the preferred embodiment of this dispersal subsystem was demonstrated in 1978 by the project known as Mini-Otec, which was conducted by a private consortium of American corporations led by Lockheed. (A thorough description of Mini-Otec and of all applications of OTEC to generating power and producing energy derived products—e.g. water, methanol, ammonia hydrogen—is found in the encyclopedic 1994 work Renewable energy from the ocean by William H. Avery and Chi Wu”. Mini-Otec was only the first of many demonstrations showing that significant amounts of electricity (1 MW or more) can be produced by the OTEC process, which utilizes the temperature gradient between cold and warm ocean water to extract heat and produce steam sufficient to drive a turbine attached to an electric generator that can produce roughly 1 MW of electricity and 800,000 liters of water a day. Larger, more expensive systems, e.g. the 10 MW plant designed for the Army to meet the complete water and power needs of the island Diego Garcia will produce 1.25 Million gallons a day. It is believed that the ability of/the preferred embodiment of this invention (combined dispersal of up to 8 Million liters a day at from one to ten carefully selected sites will validate effectiveness of the system. Extending the embodiment to yield larger amounts of water from (perhaps) fewer platforms would be a reasonable second embodiment, which would only require a reworking of the Data subsystem to select different or fewer dispersal sites.

An efficient way to produce water by the OTEC process is to locate the plants on land, which requires pumping cold water from 0 to 6 miles from the shore when depths of 1000 feet or more are available at that distance, as they are in this preferred embodiment. This approach has been demonstrated in successful experiments to acquire water for desalination by OTEC systems and components. The governments of larger islands might opt to use OTEC-tested cold water pumping equipment rather than complete OTEC platforms in the Dispersal subsystem if they have adequate electricity to operate the pumping equipment and if the cost and environmental tradeoffs are acceptable. Similarly, for the many small tropical islands, the OTEC option has enhanced appeal in that it could offer vital help with energy and water shortages in addition to its role in hurricane protection A variation that is nearly as efficient and inexpensive as importing cold water from offshore is to moor platforms a short distance from shore when the depth (1,000 feet or more) can provide the required cold water. Sites selected in this embodiment meet requirements for both alternatives. If a prospective hurricane track falls outside the series of 50 mile wide swaths leading a tropical storm toward hurricane status or, a hurricane itself has evaded prevention and is heading toward land or the Gulf of Mexico, an additional embodiment would be to install an OTEC platform on small barges grazing at 5 knots in areas not covered by fixed platforms. Excess electricity from a 1 MW unit could easily run the a small engine needed for locomotion and maneuvering. This embodiment is used by the government of India in desalinating a long stretch of their Southern shore.

### DRAWINGS NUMBERED AND DEFINED

1. Block diagram of system

2 a&b two site location maps showing likely sites for cold-water dispersions in the Caribbean Sea and Bahamas.

Other figures:

3 a, b, & c Exemplary National Hurricane Center web-site pictures depicting real-time daily location and progress of hurricanes and tropical storms.

4 a, b, c, &d Exemplary National Hurricane Center annual web-site reviews of tropical storm tracks (yellow,), hurricanes (red), depressions green}

5a &b overlays of historical pictures showing several years of annual tracks.

1979 photograph of 1 MW OTEC plant ship developed with private funds.

What is claimed is:

1) A system comprised of three subsystems to assess the likelihood, location and progress of a tropical storm's, hurricane's or typhoon's formation in tropical waters and to stop or abate its development and progress by lowering the temperature of such waters so that the tropical storm or hurricane either does not form, or if formed, will become less intense.
previous and recent historical tracks and daily real-time data on the projected path of the storm or hurricane, both provided by the National Hurricane Service, or in other parts of the world, similar data when available from other government authorities

2) The system of claim (1) by which a Data subsystem of the system determines the likely course that a disturbance or hurricane will take as soon as it is identified based on analysis of many

3) The system of claims (1) and (2) by which a Communications subsystem of the system communicates the need to cool one or more areas of tropical water to the degree at which tropical storms and hurricanes do not develop, or if they have already developed to the level that they are unlikely to increase in wind speed. This subsystem combines inputs on present and predicted storm locations and the geographical locations of the platform(s) with daily temperature readings taken at each site from which dispersals of cold water can be made. Commands for quantities of dispersal to be made and for how long are sent regularly to the dispersal platforms by email text messages, radio-telephone or, other available communications means.

4) The system of claims (1) (2) and (3) by which the Dispersal subsystem executes the commands received from the Communications subsystem. The Dispersal subsystem consists of one or more platforms from which cold or cool water is disbursed according to commands from the communications subsystem. The receiving equipment consists of tested state-of-the-art pumps for bringing cold water up from depths of 1,000 feet or more to stable platforms on land or sea where cold water is dispersed directly by gravity to cool the surface of tropical waters.

5) The system of claims (1) and (4) in which cold water is used to cool warm tropical surface water by employing Thermal Energy Conversion n (OTEC) principles and state-of-the-art practices and equipment to acquire cool water and dispense it directly by gravity on topical surface water without using any external power

6) The system of claims (1), (4), and (5) in which cold water brought up from depths of 1,000 feet or more is used in the OTEC process for producing energy and cool water and dispensing it by gravity from a slowly moving platform with excess power developed in the process is used to power a small engine which enables the platform to move and maneuver.

7) The system of claims (1), (4) and 5 in which cold water is brought from depths of 1,000 to 3,000 feet to a barge or barges moving slowly in the Caribbean, Atlantic Ocean or Gulf of Mexico for use according to the OTEC principle in generating electricity, water for dispersal on the sea surface and provide continuous power to operate a small engine to move and maneuver the vessel.
